(19) United States
(12) Patent Application Publication
(10) Pub. No.: US 2011/0196098 A1
(43) Pub. Date: Aug. 11, 2011

(54) POLYESTER MIXTURE WITH IMPROVED FLOWABILITY AND GOOD MECHANICAL PROPERTIES

(75) Inventors: Claudia Mettlach, Mannheim (DE); Andreas Eipper, Ludwigshafen (DE); Bernd Bruchmann, Freinsheim (DE); Martin Weber, Maikammer (DE); Motonori Yamamoto, Mannheim (DE); Chirag Tejuja, Singapur (SG); Carsten Weiss, Ludwigshafen (DE)

(73) Assignee: BASF SE

(21) Appl. No.: 12/673,180

(22) PCT Filed: Aug. 13, 2008
(86) PCT No.: PCT/EP08/60626

§ 371 Date: Feb. 12, 2010

(30) Foreign Application Priority Data
Aug. 15, 2007 (EP) 07114384.6

(51) Int. Cl. C08L 67/02; C08L 69/00; C08L 55/02

(52) U.S. Cl. 525/166; 525/439

(57) ABSTRACT

The invention relates to polyester mixtures, comprising
A) from 30 to 98% by weight of at least one thermoplastic aromatic polyester,
B) from 0.01 to 15% by weight of
B1) at least one highly branched or hyperbranched polycarbonate, or
B2) at least one highly branched or hyperbranched polyester or a mixture of these
C) from 1 to 20% by weight of a polyester based on aliphatic and aromatic dicarboxylic acids and on an aliphatic dihydroxy compound,
D) from 0 to 60% by weight of other additives,
   where the total of the percentages by weight of components A) to D) is 100%; and to their use, and also to fibers, foils, and moldings obtainable from these polyester mixtures.

The invention relates to polyester mixtures, comprising
A) from 30 to 98% by weight of at least one thermoplastic aromatic polyester,
B) from 0.01 to 15% by weight of
B1) at least one highly branched or hyperbranched polycarbonate, or
B2) at least one highly branched or hyperbranched polyester or a mixture of these
C) from 1 to 20% by weight of a polyester based on aliphatic and aromatic dicarboxylic acids and on an aliphatic dihydroxy compound,
D) from 0 to 60% by weight of other additives,
   where the total of the percentages by weight of components A) to D) is 100%; and to their use, and also to fibers, foils, and moldings obtainable from these polyester mixtures.

The prior art has previously disclosed approaches to improvement of the mechanical properties and the flow behavior of polyesters, such as PBT.

WO 2004/078844 describes polyester mixtures composed of PBT (component A) and of an aliphatic-aromatic polyester (component C) for improvement of flexural stiffness, in particular of bristles. WO 2004/078844 does not use flow improvers.

WO 2005/075565 discloses improved-flow polyester mixtures. Flow improvers used are highly branched and hyperbranched polycarbonates (component B1). The improved-flow polyester mixtures are, however, not always entirely satisfactory with regard to their mechanical properties, for example with regard to elongation or to tensile strain at break.

Finally, WO 2006/018127 describes polyester mixtures which comprise not only flow improvers but also rubbers as impact modifiers (component D1). Mechanical properties can be improved in these mixtures, but addition of the rubbers in turn impairs flow behavior.

An object was therefore to find a highly flowable polyester with markedly improved rheological properties which simultaneously has excellent mechanical properties.

Surprisingly, the object was achieved via the inventive polyester mixtures, which use a combination composed of flow improvers (component B) and of aliphatic-aromatic polyesters (component C).

In one preferred embodiment, impact modifiers (component D1) can be added. It is interesting that the flow behavior of the polyester mixtures is not significantly impaired by the addition of impact modifiers, and in the presence of the aliphatic-aromatic polyesters.

In another preferred embodiment, fiber-reinforced polyester mixtures are provided.

The inventive polyester mixtures are described in more detail below.

The inventive molding compositions comprise, as component A), from 30 to 98% by weight, preferably from 50 to 98% by weight, and in particular from 90 to 97% by weight, of at least one thermoplastic polyester which differs from components B2) and C).

Polyesters A) based on aromatic dicarboxylic acids and on an aliphatic or aromatic dihydroxy compound are generally used. Preference is given to poly-C₂-C₁₀-alkylene terephthalates, and particular preference is given to polybutylene terephthalate (PBT).

These polyalkylene terephthalates are known per se and are described in the literature.

The specifications WO 2005/075565 and WO 2006/018127, which are expressly incorporated herein by way of reference, give a very detailed description of component A with regard inter alia to
partial replacement of the terephthalic acid by other dicarboxylic acids,
replacement of the aliphatic diol component by aromatic diols (phenols),
polyester block copolymers, copolycarbonates, polycarbonates,
the production of polyesters such as PBT inter alia from recycled materials.

The inventive molding compositions comprise, as component B), from 0.01 to 15% by weight, preferably from 0.3 to 15% by weight, and in particular from 0.5 to 10% by weight, of B1) at least one highly branched or hyperbranched polycarbonate with an OH number of from 1 to 600 mg KOH/g of polycarbonate, preferably from 10 to 550 mg KOH/g of polycarbonate, and in particular from 50 to 550 mg KOH/g of polycarbonate (to DIN 53240, Part 2), or of at least one hyperbranched polyester, as component B2), or a mixture of these, as explained below.

For the purposes of this invention, hyperbranched polycarbonates B1) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

Component B1) preferably has a number-average molar mass Mn of from 100 to 15 000 g/mol, preferably from 200 to 12 000 g/mol, and in particular from 500 to 10 000 g/mol (GPC, PMMA standard).

The glass transition temperature Tg is in particular from −80° C. to +140° C., preferably from −60 to 120° C. (by DSC, to DIN 53765).

Viscosity (mPas) at 23° C. (to DIN 53019) is in particular from 50 to 200 000, in particular from 100 to 150 000, and very particularly preferably from 200 to 100 000.

The specifications WO 2005/075565 and WO 2006/018127, which are expressly incorporated herein by way of reference, give a very detailed description of component B1 with regard inter alia to
definition of “hyperbranched” and “dendrimeric”,
production process relating to condensates (K) and polycondensates (P),
selection of suitable diol component,
high-functionality polycarbonate,

The inventive molding compositions can comprise, as component B2), at least one hyperbranched polyester of A×By type, where

x is at least 1.1, preferably at least 1.3, in particular at least 2
y is at least 2.1, preferably at least 2.5, in particular at least 3.

It is, of course, also possible to use mixtures as units A or B.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B2) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

Component B2) preferably has an Mₙ of from 300 to 30 000 g/mol, in particular from 400 to 25 000 g/mol, and very particularly from 500 to 20 000 g/mol, determined by means of GPC, PMMA standard, dimethylacetamide eluent.

B2) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

T_{g} is preferably from −50° C. to 140° C., and in particular from −50 to 100° C. (by DSC, to DIN 53765).

Preference is particularly given to those components B2) in which at least one OH or COOH number is greater than 0, preferably greater than 0.1, and in particular greater than 0.5.

Inventive component B2) can be obtained via the processes described in WO 2006/018127, by
(a) one or more dicarboxylic acids or one or more derivatives of the same with one or more at least trihydric alcohols
or
(b) one or more tricarboxylic acids or higher polycarboxylic acids or one or more derivatives of the same with one or more diols

WO 2006/018127, which is expressly incorporated herein by way of reference, gives a very detailed description of component B2 with regard inter alia to
the definition of “hyperbranched” and “dendrimeric”,
the preferred production process (see the abovementioned variants a and b)
suitable acid component
suitable alcohol component.

The inventive polyesters have a molar mass M_{w} of from 500 to 50 000 g/mol, preferably from 1000 to 20 000 g/mol, particularly preferably from 1000 to 19 000 g/mol. Polydispersity is from 1.2 to 50, preferably from 1.4 to 40, particularly preferably from 1.5 to 30, and very particularly preferably from 1.5 to 10. They usually have good solubility, i.e. clear solutions can be prepared using up to 50% by weight, indeed in some cases up to 80% by weight, of the inventive polyesters in tetrahydrofuran (THF), n-butyl acetate, ethanol, and numerous other solvents, without any gel particles detectable by the naked eye.

The inventive high-functionality hyperbranched polyesters are carboxy-terminated, terminated by carboxy groups and by hydroxy groups, and preferably terminated by hydroxy groups.

The ratios of the components B1) to B2) are preferably from 1:20 to 20:1, in particular from 1:15 to 15:1, and very particularly from 1:5 to 5:1, if these are used in a mixture.

In principle, component C used can comprise polyesters based on aliphatic and aromatic dicarboxylic acids and on an aliphatic dihydroxy compound, these being known as semiaromatic polyesters. Mixtures of a plurality of these polyesters are, of course, also suitable as component C.

According to the invention, polyester derivatives, such as polyetheresters, polyesteramides, or polyetheresteramides, are also understood to be semiaromatic polyesters. Among the suitable semiaromatic polyesters are linear non-chain-extended polyesters (WO 92/09654). Preference is given to chain-extended and/or branched semiaromatic polyesters. The latter are disclosed in the specifications WO 96/15173 and WO 2006/074815, which are expressly incorporated herein by way of reference. Mixtures of different semiaromatic polyesters can likewise be used. Semiaromatic polyesters also include in particular products such as Ecoflex® (BASF Aktiengesellschaft), Eastar® Bio, and Origo-Bi (Novamont).

Among the particularly preferred semiaromatic polyesters are polyesters which contain, as essential components,
a) an acid component composed of
   a1) from 35 to 99 mol % of at least one aliphatic, or at least one cycloaliphatic, dicarboxylic acid, or its ester-forming derivatives, or a mixture of these
   a2) from 1 to 65 mol % of at least one aromatic dicarboxylic acid, or its ester-forming derivative, or a mixture of these, and
   a3) from 0 to 5 mol % of a compound comprising sulfonate groups,
b) a diol component composed of at least one C₂-C₁₂ alkanediol and of at least one C₅-C₁₀ cycloalkanediol, or a mixture of these,
and, if desired, also one or more components selected from
c) a component selected from
   c1) at least one dihydroxy compound comprising ether functions and having the formula I

HO—[(CH₂)ₙ—O]ₘ—H (I)
where n is 2, 3 or 4 and m is a whole number from 2 to 250,
c2) at least one hydroxycarboxylic acid of the formula IIa or IIb

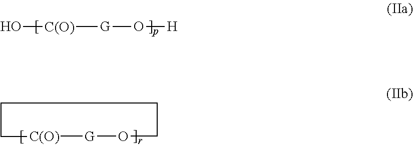

where p is a whole number from 1 to 1500 and r is a whole number from 1 to 4, and G is a radical selected from the group consisting of phenylene, —(CH₂)_{q}—, where q is a whole number from 1 to 5, —C(R)H— and —C(R)HCH₂, where R is methyl or ethyl,
c3) at least one amino-C₂-C₁₂ alkanol, or at least one amino-C₅-C₁₀ cycloalkanol, or a mixture of these,
c4) at least one diamino-C₁-C₈ alkane,
c5) at least one 2,2′-bisoxazoline of the general formula III

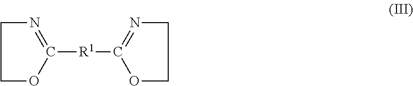

where R¹ is a single bond, a (CH₂)_{z}-alkylene group, where z=2, 3 or 4, or a phenylene group, and
c6) at least one aminocarboxylic acid selected from the group consisting of the naturally occurring amino acids, polyamides obtainable by polycondensing a dicarboxylic acid having from 4 to 6 carbon atoms with a diamine having from 4 to 10 carbon atoms, compounds of the formulae IVa and IVb

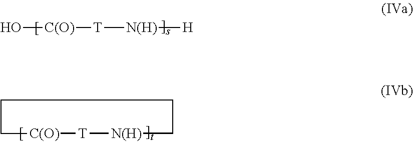

where s is an integer from 1 to 1500 and t is a whole number from 1 to 4, and T is a radical selected from the group consisting of phenylene, —(CH₂)ᵣ, where u is a whole number from 1 to 12, —C(R²)H— and —C(R²)HCH₂—, where R² is methyl or ethyl,
and polyoxazolines having the repeat unit V

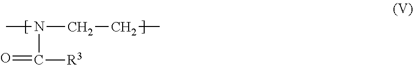

where R³ is hydrogen, C₁-C₆-alkyl, C₅-C₈-cycloalkyl, phenyl, either unsubstituted or with up to three C₁-C₄-alkyl substituents, or tetrahydrofuryl,
or a mixture composed of c1 to c6,
and of
d) a component selected from
   d1) at least one compound having at least three groups capable of ester formation,
   d2) at least one isocyanate, and
   d3) at least one divinyl ether,
   or a mixture composed of d1) to d3).

In one preferred embodiment, the acid component a) of the semiaromatic polyesters comprises from 35 to 70 mol %, in particular from 40 to 60 mol %, of a1, and from 30 to 65 mol %, in particular from 40 to 60 mol %, of a2.

Particular preference is given, as component C), to a copolymer composed of
ca₁) from 40 to 60% by weight, based on the total weight of components a1) and a2), of at least one succinic, adipic, or sebacic acid, or ester-forming derivatives thereof, or a mixture thereof,
ca₂) from 40 to 60% by weight, based on the total weight of components a1) and a2), of terephthalic acid or ester-forming derivatives thereof, or a mixture thereof,
cb) 100 mol %, based on components a1) and a2), of 1,4-butanediol or 1,3-propanediol, or a mixture thereof, as diol component,
cd₁) from 0 to 1% by weight of a compound having at least three groups capable of ester formation, as branching agent;
cd₂) from 0 to 2% by weight of a diisocyanate, as chain extender.

The semiaromatic polyesters C mentioned are generally biodegradable.

For the purposes of the present invention, a substance or a mixture of substances complies with the feature termed “biodegradable” if this substance or mixture of substances has a percentage degree of biodegradation of at least 60% in at least one of the three processes defined in DIN V 54900-2 (preliminary standard, as at September 1998).

The preferred semiaromatic polyesters are characterized by a molar mass (Mₙ) in the range from 1000 to 100 000 g/mol, in particular in the range from 9000 to 75 000 g/mol, preferably in the range from 10 000 to 50 000 g/mol, and a melting point in the range from 60 to 170° C., preferably in the range from 80 to 150° C.

The semiaromatic polyesters mentioned can have hydroxy and/or carboxy end groups in any desired ratio. The semiaromatic polyesters mentioned can also be end-group-modified. By way of example, therefore, OH end groups can be acid-modified via reaction with phthalic acid, phthalic anhydride, trimellitic acid, trimellitic anhydride, pyromellitic acid, or pyromellitic anhydride.

The inventive thermoplastic molding compositions comprise, as component (D1), from 1 to 20% by weight, preferably from 1 to 15% by weight, of an impact-modifying polymer (often also termed elastomeric polymer or elastomer).

Preferred elastomeric polymers are the polymers described in WO 2006/018127 and based on olefins and composed of the following components:
d₁) from 40 to 100% by weight, preferably from 55 to 79.5% by weight, of at least one α-olefin having from 2 to 8 carbon atoms,
d₂) from 0 to 90% by weight of a diene,
d₃) from 0 to 45% by weight, preferably from 20 to 40% by weight, of a C₁-C₁₂-alkyl ester of acrylic acid or methacrylic acid, or a mixture of these esters,
d₄) from 0 to 40% by weight, preferably from 0.5 to 20% by weight, of an ethylenically unsaturated mono- or dicarboxylic acid, or of a functional derivative of such an acid,
d₅) from 0 to 40% by weight of a monomer comprising epoxy groups,
d₆) from 0 to 5% by weight of other monomers capable of free-radical polymerization,
   with the proviso that component (D1) is not an olefin homopolymer, since that method, e.g. using polyethylene, does not achieve the advantageous effects to the same extent.

A first preferred group that may be mentioned is that of what are known as ethylene-propylene (EPM) rubbers or ethylene-propylene-diene (EPDM) rubbers, whose ratio of ethylene units to propylene units is preferably in the range from 40:60 to 90:10.
d₁) from 55 to 79.5% by weight of at least one α-olefin having from 2 to 8 carbon atoms,
d₃) from 20 to 40% by weight of a C₁-C₁₂-alkyl ester of acrylic acid or methacrylic acid, or a mixture of these esters,
d₄) from 0.5 to 20% by weight of an ethylenically unsaturated mono- or dicarboxylic acid, or of a functional derivative of such an acid,
d₅) from 0 to 20% by weight of a monomer comprising epoxy groups.

WO 2006/018127, which is expressly incorporated herein by way of reference, describes these rubbers in detail.

Examples of particularly preferred components D1) are MBS rubbers composed of:

from 65 to 99% by weight of a core composed of
d2) from 90 to 100% by weight of a diene, and from 0 to 10% by weight of other crosslinkable monomers,
and also from 1 to 35% by weight of a shell composed of
d7) from 1 to 30% by weight of styrene or unsaturated styrenes, or a mixture thereof, and
d8) from 70 to 100% by weight of at least one unsaturated nitrile.

WO 2006/018127, which is expressly incorporated herein by way of reference, describes these rubbers in detail.

Another group of preferred olefin polymers is provided by copolymers of α-olefins having from 2 to 8 carbon atoms, in particular of ethylene, with C₁-C₁₈-alkyl esters of acrylic acid and/or methacrylic acid.

WO 2006/018127, which is expressly incorporated herein by way of reference, gives a more detailed specific description of these olefin polymers, and also of the individual components d3 to d8.

Particular preference is given to olefin polymers composed of:
from 50 to 98.9% by weight, in particular from 55 to 65% by weight of ethylene,
from 0.1 to 20% by weight, in particular from 0.15 to 10% by weight, of glycidyl acrylate and/or glycidyl methacrylate, acrylic acid, and/or maleic anhydride,
from 1 to 45% by weight, in particular from 25 to 40% by weight, of n-butyl acrylate and/or 2-ethylhexyl acrylate, and also
from 0 to 10% by weight, in particular from 0.1 to 3% by weight, of maleic anhydride or fumaric acid, or a mixture thereof,
   and these are likewise described in WO 2006/018127.

Preference is further given to acrylate rubbers D1) composed of:
a) from 70 to 90% by weight and preferably from 75 to 85% by weight of crosslinked elastomeric core, which is composed of:
   1) from 20 to 90% by weight of a core composed of a copolymer (I) of an n-alkyl acrylate whose alkyl group has from 5 to 12 carbon atoms and preferably from 5 to 8 carbon atoms, or of a mixture of alkyl acrylates, where the number of the carbon atoms in straight-chain or branched alkyl groups is in the range from 2 to 12 and preferably from 4 to 8; of a polyfunctional crosslinking agent, where this molecule has unsaturated groups and, among these, at least one CH₂═C<group of vinyl type, and, if appropriate, is composed of a polyfunctional grafting agent, where this molecule has unsaturated groups and, among these, at least one CH₂═CH—CH₂— group of allyl type, where the core contains a molar amount of the crosslinking agent and, if appropriate, of the grafting agent, of from 0.05 to 5%, and the amount is preferably from 0.5 to 1.5% by weight,
   2) from 80 to 10% by weight of a shell which is composed of a copolymer (II) of an n-alkyl acrylate whose alkyl group has from 4 to 12 carbon atoms and preferably from 4 to 8 carbon atoms, or of a mixture of alkyl acrylates as defined under 1), and of a polyfunctional grafting agent, where this molecule has unsaturated groups and, among these, at least one CH₂═CH—CH₂— group of allyl type, where the shell contains a molar amount of from 0.05 to 2.5% of the grafting agent, and the amount is preferably from 0.5 to 1.5% by weight, and
b) from 30 to 10% by weight, and preferably from 25 to 15% by weight, of a shell, grafted onto the core and composed of an alkyl methacrylate polymer whose alkyl group has from 1 to 4 carbon atoms, or composed of a random copolymer of an alkyl methacrylate whose alkyl group has from 1 to 4 carbon atoms with an alkyl acrylate whose alkyl group has from 1 to 8 carbon atoms, the molar amount present of the alkyl acrylate being from 5 to 40% and preferably in the range from 10 to 20%.

WO 2006/018127, which is expressly incorporated herein by way of reference, gives a more detailed description of the acrylate rubbers D1.

A thermoplastic elastomer based on TPEE (thermoplastic polyester elastomers) can also be used as component D1. These products are marketed inter alia with trademark Pibiflex®, for example E4090, from P-Group, Italy, or Hytrel® (DuPont), or Arnitel® (Akzo), or else Pelprene® (Toyobo Co. Ltd). These products have a crystalline PBT fraction and a polyethylene glycol fraction as soft segment, and are described in detail in the specification WO 2007/009930, which is expressly incorporated herein by way of reference.

TPEE has short-chain units of the formula:

—O-D-O—CO—R—CO (I)

and long-chain units having the formula:

—O-G-OCO—R—CO— (IIa)

—O-D-O—CO—R—CO (IIb)

where
D derives from an alkylene glycol, such as 1,4-butanediol, and has a molecular weight of about 250;
R derives from a carboxylic acid, such as terephthalic acid, and has a molecular weight below 300;
G derives from a long-chain diol with a molecular weight of from about 250 to 6000; and
O is oxygen.

Further preferred impact modifiers D1 that can be used are thermoplastic elastomers of TPU type as by way of example available with trademark Elastollan® from Elastogran. The elastomers generally have a soft segment formed from a diisocyanate and from a long-chain diol, where the latter in turn can comprise ether or ester groups, and a hard segment, formed from diisocyanates and from short-chain diols. As a function of the constitution of the long-chain diol, the term polyester polyols or polyether polyols is used.

The preferred quantitative proportion of the impact modifier D1 introduced into the thermoplastic polymer is in the range from 1 to 20% by weight and preferably from 1 to 15% by weight, based on 100% by weight of the thermoplastic polymer used.

Fibrous or particulate fillers D2) that can be used are carbon fibers, glass fibers, glass beads, amorphous silica, asbestos, calcium silicate, calcium metasilicate, magnesium carbonate, kaolin, chalk, powdered quartz, mica, barium sulfate, and feldspar, their amounts being up to 50% by weight, in particular up to 30%.

Preferred fibrous fillers that may be mentioned are carbon fibers, aramid fibers, and potassium titanate fibers, particular preference being given to glass fibers in the form of E glass. These can be used as rovings or chopped glass in the forms commercially available. The thickness of the glass fibers is generally about 10 μm.

To improve compatibility with the thermoplastic, the fibrous fillers may have been pretreated on the surface with a silane compound. WO 2006/018127, which is expressly incorporated herein by way of reference, gives a more detailed description of the silane-modification process.

The inventive molding compositions can moreover comprise conventional processing aids, such as stabilizers, oxidation retarders, agents to counteract decomposition by heat and decomposition by ultraviolet light, lubricants and mold-release agents, colorants, such as dyes and pigments, plasticizers, nucleating agents, and compatibilizers.

Examples mentioned of oxidation retarders and heat stabilizers are sterically hindered phenols and/or phosphites, hydroquinones, aromatic secondary amines, such as diphenylamines, and various substituted representatives of these groups, and mixtures thereof, in concentrations up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzene-sulfonamide.

The inventive molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-containing ethylene polymers and the incorporation of these into a polyester melt.

The inventive thermoplastic molding compositions may be prepared by methods known per se, by mixing the starting components in conventional mixing apparatus, such as screw extruders, Brabender mixers or Banbury mixers, and then extruding them. The extrudate may be cooled and comminuted. It is also possible to premix individual components and then to add the remaining starting materials individually and/or likewise in a mixture. The mixing temperatures are generally from 230 to 290° C.

In another preferred procedure, components A and C, and also, if appropriate, D1 can be charged, premixed, to the extruder, and component B can preferably be added dropwise by a hot-feed method, and component D2 can likewise be added at a later juncture to the extruder by a hot-feed method. The final extrudate can, if appropriate, be compounded and pelletized.

A feature of the inventive thermoplastic molding compositions is good flowability simultaneously with good mechanical properties.

In particular, processing of the individual components is possible without difficulty (without clumping or caking), and in short cycle times, a particular possible application therefore being thin-walled components.

The use for an improved-flow polyester is conceivable in almost any injection-molding application. The improved flow can give a lower melt temperature and can therefore lead to a marked lowering of the total cycle time for the injection-molding process (lowering of production costs for an injection molding!). Furthermore, lower injection pressures are needed during processing, and a lower total clamping force is therefore needed on the injection mold (lower capital expenditure for the injection-molding machine).

Alongside the improvements in the injection-molding process, the lowering of melt viscosity can lead to marked advantages in the actual design of the component. By way of example, thin-walled applications which hitherto, for example, were not achievable using filled grades of polyester, can be produced by way of injection molding. By analogy with this, it is conceivable that the use of reinforced grades of polyester that have improved flow will reduce wall thicknesses in existing applications, and therefore reduce component weights.

These materials are suitable for production of fibers, of foils, and of moldings of any type, in particular for applications as plugs, switches, housing parts, housing covers, headlamp bezels, shower heads, fittings, smoothing irons, rotary switches, stove controls, fryer lids, door handles, (rear) mirror housings, (tailgate) screen wipers, or sheathing for optical conductors.

Electronic and electrical applications which can be produced using the improved-flow polyesters are plugs, plug components, plug connectors, cable harness components, circuit mounts, circuit mount components, three-dimensionally injection-molded circuit mounts, electrical connectors, mechatronic components, or optoelectronic components.

Possible uses in automobile interiors are for dashboards, steering column switches, seat components, headrests, center consoles, gearbox components, and door modules, and possible automobile exterior components are door handles, headlamp components, exterior mirror components, windshield washer components, windshield washer protective housings, grilles, roof rails, sunroof frames, and exterior bodywork parts.

Possible uses of the improved-flow polyester in the kitchen and household sector are production of components for kitchen equipment, e.g. fryers, smoothing irons, buttons, and also garden and leisure sector applications, such as components for irrigation systems or garden equipment.

In the medical technology sector, it becomes simpler to produce inhaler housings and components of these via improved-flow polyesters.

General operating specification for production of inventive polyester mixtures:

Each of the compounding materials described in the examples was produced in a ZSK 30 twin-screw extruder using a processing temperature of 260° C. PBT was premixed here with the additives C and, if appropriate, D1 in the form of a premix, and charged to the extruder feed. The glass fiber (D2) was charged to the middle of the extruder by a hot-feed method. The flow improver (B) was added dropwise to the polymer melt by a hot-feed method, by means of a pump. The additive B can also optionally be concomitantly added dropwise to the intake, or can be applied in a mixing drum to the premix. To test mechanical properties, dumbbell specimens were produced to ISO 527-2 and the tensile test was carried out to ISO 527-2 (exception: Inventive Example 3, see description). Impact resistance was also determined to ISO179-2, as were viscosity number (VN: ISO 1628 in phenol/o-dichlorobenzene, 1:1, 25° C.), and flowability by means of MVR (ISO 1133).

### Starting Materials

### Component A) (Aromatic Polyester):

A1) Ultradur® B4500 from BASF Aktiengesellschaft (PBT VN 130)
A2) Ultradur® B4520 from BASF Aktiengesellschaft (PBT VN 130+0.65% by weight of pentaerythritol tetrastearate as lubricant)

### Component B) (Flow Improver):

Polycarbonate produced from diethyl carbonate and from a polyol (trimethylolpropane×1.2 ethylene oxide) see Example B/6 in WO 2005/075565)

### Component C) (Semiaromatic Polyester):

Ecoflex® FBX 7011 from BASF Aktiengesellschaft

### Component D1) (Impact Modifier):

D1.1): Pipiflex® E4090 from P-Group, Italy (TPEE)
D1.2) Paraloid® BXL 3670 from Rohm&Haas (MBS rubber)

### Component D2) (Glass Fiber):

Glass fiber PPG 3786 from PPG with thickness of 10 μm

TABLE 1
Production of unreinforced improved-flow PBT with good
mechanical properties via addition of component C

| Starting materials | comp 1 | 2 | comp 3 |
|---|---|---|---|
| A1 | 98.95 | 93.95 | 94.35 |
| Pentaerythritol tetrastearate | 0.65 | 0.65 | 0.65 |
| B | 0.40 | 0.40 | |
| C | | 5.00 | 5.00 |
| VN [ml/g] | 111.3 | 110.7 | 126.0 |
| MVR 250° C. 2.16 kg [cm³/10 min] | 40.0 | 45.9 | 28.5 |
| HDT/B/standard deviation [° C.] | — | 119.8/127.3 | 105.7 |
| Modulus of elasticity [MPa] | 2567 | 2152 | 2250 |
| Yield stress σ_M[MPa] | 56.86 | 51.37 | 51.95 |
| Tensile stress at break σ_B [MPa] | 22.53 | 32.68 | 35.05 |
| Elongation ε_M [%] | 3.6 | 9.82 | 9.58 |
| Tensile strain at break ε_tB [%] | 69.22 | 228.68 | 251.09 |
| Charpy notched [kJ/m²] | 4.6 | 5.4 | 5.8 |
| Charpy without notch, 23° C. [kJ/m²] | 232.8 | 250/278 | 294 |
| Charpy without notch, −30° C. [kJ/m²] | 165.0 | 156.0 | 220.3 |

TABLE 2
Production of unreinforced improved-flow PBT with good mechanical properties via
addition of component C and impact modifiers D1

| Starting materials | comp 4 | comp 5 | comp 6 | 7 | 8 | comp 9 | 10 | 11 |
|---|---|---|---|---|---|---|---|---|
| A1 | 99.35 | 98.85 | 93.85 | 93.85 | 92.85 | 93.85 | 93.85 | 92.85 |
| Pentaerythritol tetrastearate | 0.65 | 0.65 | 0.65 | 0.65 | 0.65 | 0.65 | 0.65 | 0.65 |
| B | | 0.50 | 0.50 | 0.50 | 0.50 | 0.50 | 0.50 | 0.50 |
| C | | | | 3.00 | 3.00 | | 3.00 | 3.00 |
| D1.1 | | | 5.00 | 2.00 | 3.00 | | | |
| D1.2 | | | | | | 5.00 | 2.00 | 3.00 |
| VN of pellets [ml/g] | 121.5 | 109.7 | 111.5 | 110.5 | 115.2 | 102.8 | 105.9 | 106.7 |
| MVR 250° C. 2.16 kg [cm³/10 min] | 29.1 | 54.0 | 47.0 | 51.7 | 50.2 | 45.0 | 52.2 | 49.1 |
| HDT/B/standard deviation [° C.] | 125.1/3.9 | 120.8/11.0 | 127.7 | 119.2 | 131.7/2.6 | 131.1 | 114.8/4.1 | 118 |
| Modulus of elasticity [MPa] | 2661 | 2663 | 2385 | 2226 | 2139 | 2314 | 2184 | 2156 |
| Yield stress σ_M [MPa] | 57.63 | 58.4 | 53.47 | 52.57 | 52.39 | 47.90 | 49.38 | 50.44 |
| Tensile stress at break σ_B [MPa] | 22.46 | 47.56 | 42.72 | 18.56 | 16.67 | 18.72 | 17.36 | 19.13 |
| Elongation ε_M [%] | 8.06 | 7.5 | 6.85 | 10.21 | 9.74 | 3.34 | 4.40 | 3.93 |
| Tensile strain at break ε_tB [%] | 49.61 | 16.83 | 17.89 | 44.04 | 33.93 | 80.65 | 125.72 | 50.9 |
| Charpy notched [kJ/m²] | 5 | 3.9 | 5.6 | 4.4 | 5.6 | 7.3 | 6.2 | 7.2 |
| Charpy without notch, 23° C. [kJ/m²] | 298 | 196 | 196 | 200 | 199.5 | 222 | 195 | 195 |
| Charpy without notch, −30° C. [kJ/m²] | 191 | 153 | 170 | 169.9 | 143 | 222.5 | 175 | 170 |

TABLE 3
Production of glassfiber-reinforced improved-flow PBT with good mechanical
properties via addition of component C

| | Starting materials | comp 12 | comp 13 | 14 |
|---|---|---|---|---|
| | A2 | 70.00 | 69.25 | 64.50 |
| | B | | 0.50 | 0.50 |
| | C | | | 5.00 |
| | D2 | 30.00 | 30.00 | 30.00 |
| Results: | VN [ml/g] | 108.8 | 98.6 | 94.8 |
| Analysis: | Residue on ignition [%] | 29.4 | 30.1 | 29.6 |
| | MVR 275° C. 2.16 kg [cm³/10 min] | 25.5 | 48.5 | 58.8 |
| Mechanical | | | | |
| properties: | | | | |
| Manufactured | Modulus of elasticity [MPa] | 9054 | 9019 | 8097 |
| longitudinally | Yield stress σ_M[MPa] | 120.4 | 125.01 | 109.17 |
| from sheets | Tensile stress at break σ_B [MPa] | 120.4 | 125.01 | 109.17 |
| Outer | Elongation ε_M [%] | 2.5 | 2.29 | 2.28 |
| Specimen 1 + | Tensile strain at break ε_B/ε_tB[%] | 2.5 | 2.29 | 2.28 |
| specimen 5 | | | | |
| Manufactured | Modulus of elasticity [MPa] | 8653 | 8743 | 7723 |
| longitudinally | Yield stress σ_M[MPa] | 115.78 | 120.56 | 105.14 |
| from sheets | Tensile stress at break σ_B [MPa] | 115.78 | 120.56 | 105.14 |
| Central | Elongation ε_M [%] | 2.65 | 2.27 | 2.4 |
| Specimen 2 + | Tensile strain at break ε_B [%] | 2.65 | 2.27 | 2.4 |
| specimen 4 | | | | |
| Manufactured | Modulus of elasticity [MPa] | 8610 | 8703 | 7666 |
| longitudinally | Yield stress σ_M[MPa] | 114.82 | 120.48 | 104.29 |
| from sheets | Tensile stress at break σ_B [MPa] | 114.82 | 120.48 | 104.29 |
| Inner | Elongation ε_M [%] | 2.47 | 2.27 | 2.36 |
| Specimen 3 | Tensile strain at break ε_B [%] | 2.47 | 2.27 | 2.36 |
| Manufactured | Modulus of elasticity [MPa] | 4764 | 4703 | 3908 |
| transversely | Yield stress σ_M[MPa] | 63.64 | 64.15 | 55.75 |
| from sheets | Tensile stress at break σ_B [MPa] | 63.64 | 64.15 | 55.75 |
| Close to sprue | Elongation ε_M [%] | 2.42 | 2.49 | 2.56 |
| Specimen 1 | Tensile strain at break ε_B/ε_tB[%] | 2.42 | 2.49 | 2.56 |
| Manufactured | Modulus of elasticity [MPa] | 4550 | 4619 | 3763 |
| transversely | Yield stress σ_M[MPa] | 63.27 | 64.95 | 55.8 |
| from sheets | Tensile stress at break σ_B [MPa] | 63.20 | 64.95 | 55.8 |
| Central | Elongation ε_M [%] | 2.76 | 2.65 | 2.82 |
| Specimen 3 | Tensile strain at break ε_B/ε_tB[%] | 2.78 | 2.65 | 2.82 |
| Manufactured | Modulus of elasticity [MPa] | 4775 | 4727 | 4004 |
| transversely | Yield stress σ_M[MPa] | 70.02 | 71.09 | 61.77 |
| from sheets | Tensile stress at break σ_B [MPa] | 69.64 | 70.98 | 61.77 |
| Far from sprue | Elongation ε_M [%] | 3.22 | 3.12 | 3.01 |
| Specimen 5 | Tensile strain at break ε_B/c_tB[%] | 3.23 | 3.05 | 3.01 |

The mechanical data shown in Table 3 were obtained from tensile tests to ISO 527-2 on tensile specimens of thickness 2 mm, which had been cut out from sheets.

The results listed in Table 1 show that the mechanical properties of injection moldings can be decisively improved via addition of semiaromatic polyesters C, such as Ecoflex. The improved tensile strain at break behavior due to addition of semiaromatic polyesters C is particularly noticeable (see Inventive Example 2), when comparison is made with PBT which comprises merely flow improver (Example comp 1).

The data collated in Table 2 show that the use of impact modifiers D1 (comp 6 and comp 9) impairs the flowability of the polyester mixtures (comp 5). There is a marked attenuation of this effect in the presence of the semiaromatic polyesters C (see Inventive Examples 7, 8, 10, and 11). Moldings produced from these mixtures moreover have excellent mechanical properties.

The data shown in Table 3 show that the addition of semiaromatic polyesters C brings about a similar favorable effect in glassfiber-reinforced PBT.

1.-9. (canceled)

10. A polyester mixture comprising
A) from 30 to 98% by weight of at least one thermoplastic aromatic polyester,
B) from 0.01 to 15% by weight of
B1) at least one highly branched or hyperbranched polycarbonate, or
B2) at least one highly branched or hyperbranched polyester
or a mixture of these
C) from 1 to 20% by weight of a polyester composed of
ca₁) from 40 to 60% by weight, based on the total weight of components a1) and a2) of at least one succinic, adipic, or sebacic acid, or ester-forming derivatives thereof, or a mixture thereof,
ca₂) from 40 to 60% by weight, based on the total weight of components a1) and a2), of terephthalic acid, or ester-forming derivatives thereof, or a mixture thereof,
cb) 100 mol %, based on components a1) and a2), of 1,4-butanediol or 1,3-propanediol, or a mixture thereof, as diol component,
cd₂) from 0 to 1% by weight of a compound having at least three groups capable of ester formation, as branching agent,
cd₂) from 0 to 2% by weight of a diisocyanate, as chain extender, and
D) from 0 to 60% by weight of other additives.

11. The polyester mixture according to claim 10, comprising
A) from 90 to 97% by weight of polybutylene terephthalate,
B) from 0.1 to 1% by weight of
B1) at least one highly branched or hyperbranched polycarbonate with an OH number of from 1 to 600 mg KOH/g of polycarbonate (to DIN 53240, Part 2), or
B2) at least one highly branched or hyperbranched polyester of AₓB_{y} type, where x is at least 1.1, and y is at least 2.1,
or a mixture of these
C) from 1 to 15% by weight of a polyester composed of
ca₁) from 40 to 60% by weight, based on the total weight of components a1) and a2) of at least one succinic, adipic, or sebacic acid, or ester-forming derivatives thereof, or a mixture thereof,
ca₂) from 40 to 60% by weight, based on the total weight of components a1) and a2), of terephthalic acid, or ester-forming derivatives thereof, or a mixture thereof,
cb₃) 100 mol %, based on components a1) and a2), of 1,4-butanediol or 1,3-propanediol, or a mixture thereof, as diol component,
cd₁) from 0 to 1% by weight of a compound having at least three groups capable of ester formation, as branching agent,
cd₂) from 0 to 2% by weight of a diisocyanate, as chain extender,
D) from 0 to 40% by weight of other additives,
where the total of the percentages by weight of components A) to D) is 100%.

12. The polyester mixture according to claim 10, in which component B1) has a number-average molar mass Mₙ of from 100 to 15 000 g/mol, a glass transition temperature T_{g} of from −80° C. to 140° C., and a viscosity (mPas) at 23° C. (to DIN 53019) of from 50 to 200 000.

13. The polyester mixture according to claim 10, in which component B2) has a number-average molar mass Mₙ of from 300 to 30 000 g/mol, a glass transition temperature T_{g} of from −50° C. to 140° C., an OH number (to DIN 53240) of from 0 to 600 mg KOH/g of polyester, and a COOH number (to DIN 53240) of from 0 to 600 mg KOH/g of polyester.

14. The polyester mixture according to claim 11, in which component B1) has a number-average molar mass Mₙ of from 100 to 15 000 g/mol, a glass transition temperature T_{g} of from −80° C. to 140° C., and a viscosity (mPas) at 23° C. (to DIN 53019) of from 50 to 200 000 and component B2) has a number-average molar mass Mₙ of from 300 to 30 000 g/mol, a glass transition temperature T_{g} of from −50° C. to 140° C., an OH number (to DIN 53240) of from 0 to 600 mg KOH/g of polyester, and a COOH number (to DIN 53240) of from 0 to 600 mg KOH/g of polyester.

15. The polyester mixture according to claim 10, in which the ratio of components B1):B2) is from 1:20 to 20:1.

16. The polyester mixture according to claim 14, in which the ratio of components B1):B2) is from 1:20 to 20:1.

17. The polyester mixture according to claim 10, comprising, as component D1), from 1 to 15% by weight of an impact modifier selected from the group consisting of, a single- or multicomponent copolymer based on an α-olefin having from 2 to 8 carbon atoms, on an MBS rubber, on an acrylate rubber, on a TPU (thermoplastic polyurethane), and on a TPEE (thermoplastic polyester elastomer).

18. The polyester mixture according to claim 16, comprising, as component D1), from 1 to 15% by weight of an impact modifier selected from the group consisting of, a single- or multicomponent copolymer based on an α-olefin having from 2 to 8 carbon atoms, on an MBS rubber, on an acrylate rubber, on a TPU (thermoplastic polyurethane), and on a TPEE (thermoplastic polyester elastomer).

19. The polyester mixture according to claim 10, comprising, as component D2), from 10 to 40% by weight of glass fibers.

20. The polyester mixture according to claim 18, comprising, as component D2), from 10 to 40% by weight of glass fibers.

21. A process for production of a fiber, a foil, or a molding which comprises utilizing the polyester mixture according to claim 10.

22. A fiber, a foil, or a molding comprising the polyester mixture according to claim 10.
